(19) United States
(12) Patent Application Publication
(10) Pub. No.: US 2008/0041925 A1
(43) Pub. Date: Feb. 21, 2008

(54) Construct for heating multiple food items in a microwave oven

(76) Inventor: Jean-Michel Cambay, Caullery (FR)

Correspondence Address: WOMBLE CARLYLE SANDRIDGE & RICE, PLLC, ATTN: PATENT DOCKETING 32ND FLOOR, P.O. BOX 7037, ATLANTA, GA, 30357-0037, US

(21) Appl. No.: 11/891,601

(22) Filed: Aug. 10, 2007

Related U.S. Application Data
(60) Provisional application No. 60/920,497, filed on Mar. 28, 2007.

(30) Foreign Application Priority Data
Aug. 11, 2006 (EP) 06291317.3

(51) Int. Cl. B65D 5/42; A47J 27/00; H05B 6/64; H05B 6/80

(52) U.S. Cl. 229/120.08; 219/730; 219/759; 220/573.1

(57) ABSTRACT

A multicompartment construct for heating a plurality of food items in a microwave oven is provided. The construct may include one or more microwave energy interactive elements for enhancing the heating, browning, and/or crisping of the food items.

### TECHNICAL FIELD

The present invention relates to various blanks, constructs, and methods for heating, browning, and/or crisping a food item, and particularly relates to various blanks, constructs, and methods for heating, browning, and/or crisping a food item in a microwave oven.

### BACKGROUND

Microwave ovens have become a principle form of heating food in a rapid and effective manner. Various attempts have been made to provide microwave food packages that produce effects associated with foods cooked in a conventional oven. Such packages must be capable of controlling the distribution of energy around the food item, utilizing the energy in the most efficient manner, and ensuring that the food item and the container provide a pleasant and acceptable finished food item. For example, where browning and/or crisping of the food item is desired, such packages often include one or more microwave energy interactive elements that convert microwave energy into thermal energy, thereby intensifying the heating of the surface of the food item. The packages often are provided for single servings of a particular food item. Thus, where multiple food items are prepared, the user often uses multiple microwave heating packages. In doing so, however, the relative positioning of the packages within the microwave oven may vary, thereby altering the distribution of microwave energy within the microwave oven. As a result, the food items may not be heated thoroughly, evenly, and in the same amount of time. Thus, there remains a need for a microwave energy interactive construct that provides the desired level of heating, browning, and/or crisping of multiple food items in a microwave oven.

### SUMMARY

The present invention relates generally to various blanks, constructs formed from such blanks, and methods of beating, browning, and/or crisping a plurality of food items in a microwave oven. The blanks of the present invention include a plurality of adjoined panels that may be used to form various multicompartment constructs for heating a plurality of food items or a plurality of servings of a food item in a microwave oven. If desired, the blanks and/or constructs of the invention may include one or more microwave energy interactive elements that enhance the beating, browning, and/or crisping of the food item or items. The various constructs may be suitable for any food item, items, or combination of items including, but not limited to, egg rolls, spring rolls, burritos, taquitos, flautas, chicken wings or other pieces, sandwiches, pizza pockets, or fruit pies. By healing a plurality of food items or servings in a single package, the distribution of microwave energy within the microwave oven is able to be controlled through design of the construct. Additionally, by heating multiple food items at the same, the overall cooking time in the microwave oven is increased, thereby allowing more time for browning and/or crisping.

According to one aspect of the invention, a blank for a construct comprises a first panel, a second panel joined to the first panel along a first fold line, a third panel joined to the second panel along a second fold line, a fourth panel joined to the third panel along a third fold line, a fifth panel joined to the first panel along a fourth fold line, and a sixth panel joined to the fifth panel along a fifth fold line, where each of the first fold line, second fold line, third fold line, fourth fold line, and fifth fold line are aligned in a substantially parallel configuration with respect to one another. In one particular example, the first panel comprises a base panel, the second panel comprises a first side panel, the third panel comprises a first top panel, the fourth panel comprises a center panel, the fifth panel comprises a second side panel, and the sixth panel comprises a second top panel.

At least one of the first panel, second panel, third panel, fourth panel, and fifth panel may be substantially rectangular in shape. In one example, each of the first panel, second panel, third panel, fourth panel, and fifth panel is substantially rectangular in shape. The sixth panel also may be substantially rectangular in shape. Alternatively, the sixth panel may be substantially hexagonal in shape. Alternatively still, the sixth panel may be substantially rectangular in shape with at least one oblique corner.

In one variation, each of the first fold line, second fold line, third fold line, fourth fold line, and fifth fold line are substantially equal in length, and the length of the first fold line, second fold line, third fold line, fourth fold line, and fifth fold line defines a first dimension of each of the first panel, second panel, third panel, fourth panel, and fifth panel. In another variation, each of the first panel, second panel, third panel, fourth panel, fifth panel, and sixth panel has a second dimension substantially transverse to the first fold line, second fold line, third fold line, fourth fold line, and fifth fold line, and the second dimension of the second panel is approximately equal to that of the fifth panel. In still another variation, each of the first panel, second panel, third panel, fourth panel, fifth panel, and sixth panel has a second dimension substantially transverse to the first fold line, second fold line, third fold line, fourth fold line, and fifth fold line, and the second dimension of the sixth panel is greater than the second dimension of the third panel.

Optionally, a microwave energy interactive element may overlie at least a portion of at least one of the first panel, second panel, third panel, fourth panel, fifth panel, and sixth panel. In one example, a susceptor is joined to at least a portion of at least one of the first panel, second panel, third panel, fourth panel, fifth panel, and six, panel. In another example, the blank includes a microwave energy interactive insulating material, a microwave energy shielding element, a microwave energy directing element, a susceptor, a segmented metal foil, or any combination thereof.

The present invention also contemplates a method of forming a construct from the blank and various constructs formed therefrom. In one aspect the construct comprises a base, a pair of opposed side walls, at least one top panel, and an interior wall that defines a first compartment and a second compartment. In one variation, the first compartment and the second compartment are substantially the same size. In another variation, the first compartment and the second compartment differ in size.

At least one of the first compartment and the second compartment may have an interior surface defined by a microwave energy interactive element. In one variation, the first compartment includes an interior surface substantially defined by a microwave energy interactive element, and the second compartment includes an interior surface partially defined by a microwave energy interactive element.

According to another aspect of the invention, a blank for a construct comprises a first panel, a second panel joined to the first panel along a first fold line, a third panel joined to the second panel along a second fold line, a fourth panel joined to the third panel along a third fold line, a fifth panel joined to the first panel along a fourth fold line, a sixth panel joined to the fifth panel along a fifth fold line, and a seventh panel joined to the sixth panel along a sixth fold line, where the first fold line, second fold line, third fold line, fourth fold line, fifth fold line, and sixth fold line each are aligned in a substantially parallel configuration with respect to one another. In one particular example, the first panel comprises a base panel, the second panel comprises a first side panel, the third panel comprises a first top panel, the fourth panel comprises a first center panel, the fifth panel comprises a second side panel, the sixth panel comprises a second top panel, and the seventh panel comprises a second center panel.

At least one of the first panel, second panel, third panel, fourth panel, fifth panel, and sixth panel may be substantially rectangular in shape. In one example, the first panel, second panel, third panel, fourth panel, fifth panel and sixth panel each am substantially rectangular in shape.

In one variation of this aspect, the first fold line, second fold line, third fold line, fourth fold lines fifth fold line, and sixth fold line are substantially equal in length, and the length of the first fold line, second fold line, third fold line, fourth fold line, fifth fold line, and sixth fold line defines a first dimension of each of the first panel, second panel, third panel, fourth panel, fifth panel, and sixth panel.

In another variation, each of the first panel, second panel, third panel, fourth panel, fifth panel, and sixth panel has a second dimension substantially transverse to the first fold line, second fold line, third fold line, fourth fold line, fifth fold line, and sixth fold line, and the second dimension of the second panel is approximately equal to that of the fifth panel, the second dimension of the third panel is approximately equal to that of the sixth panel, and the second dimension of the fourth panel is approximately equal to that of the seventh panel.

If desired, the blank may comprise a microwave energy interactive element overlying at least a portion of at least one of the first panel, second panel, third panel, fourth panel, fifth panel, sixth panel, and seventh panel. In one variation, a susceptor is joined to at least a portion of at least one of the first panel, second panel, third panel, fourth panel, fifth panel, sixth panel, and seventh panel. In another variation, the blank includes a microwave energy interactive insulating material, a microwave energy shielding element, a microwave energy directing element, a susceptor, a segmented metal foil, or any combination thereof.

The present invention also contemplates a method of forming a construct from the blank and a construct formed therefrom. In one aspect, the construct comprises a base, a pair of opposed side walls, at least one top panel, and a pair of substantially interior walls that collectively define a first compartment and a second compartment. The first compartment and the second compartment may be substantially the same size and/or shape or may differ in size and/or shape. In one variation, at least one of the first compartment and the second compartment has an interior surface defined by a microwave energy interactive element. In another variation, the first compartment and the second compartment each have an interior surface substantially defined by a microwave energy interactive element.

Other features, aspects, and embodiments will be apparent from the following description and accompanying figures.

### BRIEF DESCRIPTION OF THE DRAWINGS

The description refers to the accompanying drawings, some of which are schematic, in which like reference characters refer to like parts throughout the several views, and in which;

FIG. 1A schematically depicts an exemplary blank in accordance with various aspects of the present invention;

FIG. 1B depicts a side view of the exemplary blank of FIG. 1A;

FIGS. 1C-1G depict an exemplary sequence of steps for forming an exemplary construct from the blank of FIG. 1A, in accordance with various aspects of the invention;

FIG. 2A schematically depicts another exemplary blank in accordance with various aspects of the present invention;

FIG. 2D depicts a side view of the exemplary blank of FIG. 2A;

FIG. 2C-2H depict an exemplary sequence of steps for forming an exemplary construct from the blank of FIG. 2A, in accordance with various aspects of the invention;

FIG. 3A depicts a schematic cross-sectional view of an exemplary microwave energy interactive insulating material that may be used to form a construct in accordance with various aspects of the present invention;

FIG. 3B depicts the exemplary microwave energy interactive insulating material of FIG. 3A, in the form of a cut sheet;

FIG. 3C depicts the exemplary microwave energy interactive insulating sheet of FIG. 3B, upon exposure to microwave energy;

FIG. 3D schematically depicts an exemplary variation of the exemplary microwave energy interactive insulating material of FIG. 3A;

FIG. 4 depicts a schematic cross-sectional view of another exemplary microwave energy interactive insulating material that may be used to form a construct in accordance with various aspects of the present invention;

FIG. 5 depicts a schematic cross-sectional view of yet another exemplary microwave energy interactive insulating material that may be used to form a construct in accordance with various aspects of the present invention;

FIG. 6A depicts a schematic cross-sectional view of still another exemplary microwave energy interactive insulating material that may be used to form a construct in accordance with various aspects of the present invention;

FIG. 6B depicts the exemplary microwave energy interactive insulating material of FIG. 6A, in the form of a cut sheet; and

FIG. 6C depicts the exemplary microwave energy interactive insulating sheet of FIG. 6B, upon exposure to microwave energy.

### DESCRIPTION

The present invention may be illustrated further by referring to the figures. For simplicity, like numerals may be used to describe like features. It will be understood that where a plurality of similar features are depicted, not all of such features necessarily are labeled on each figure. It also will be understood that various components used to form the blanks and constructs of the present invention may be interchanged. Thus, while only certain combinations are illustrated herein, numerous other combinations and configurations are contemplated hereby.

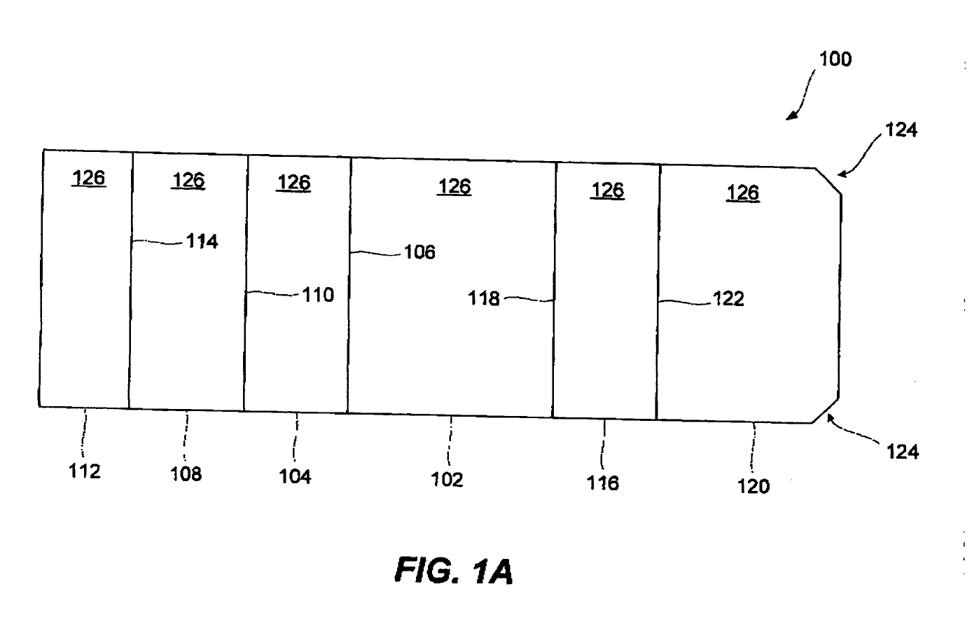

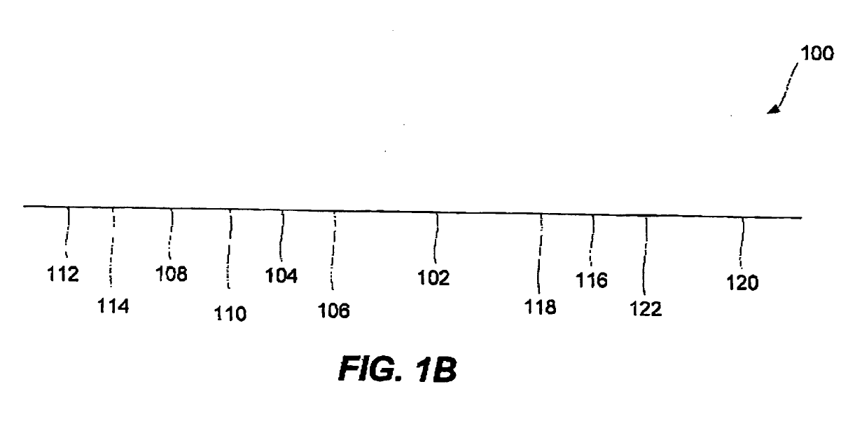

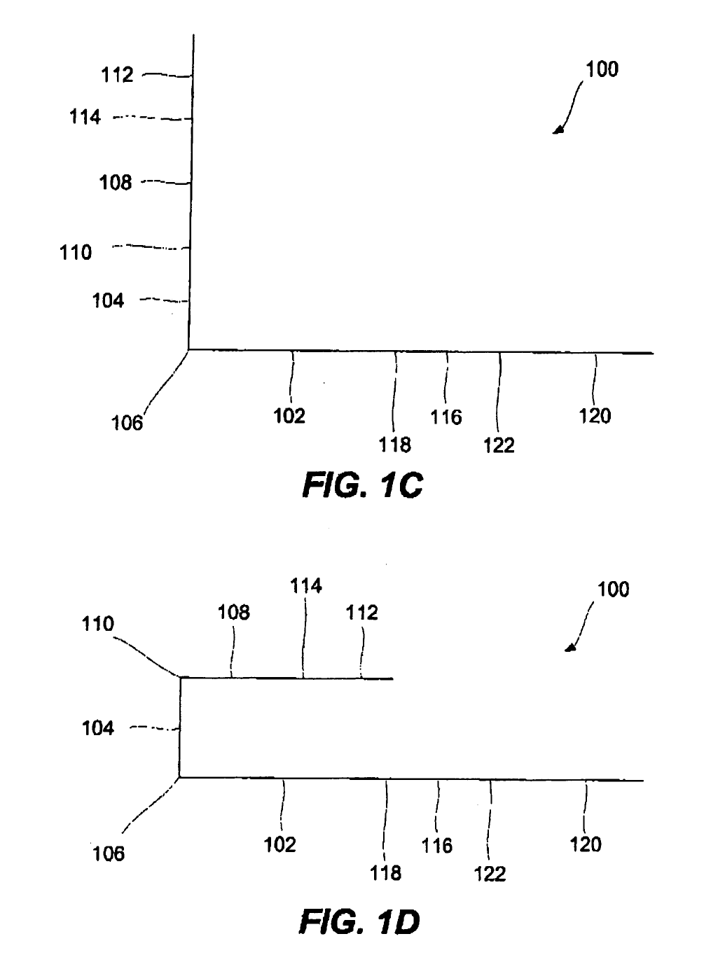

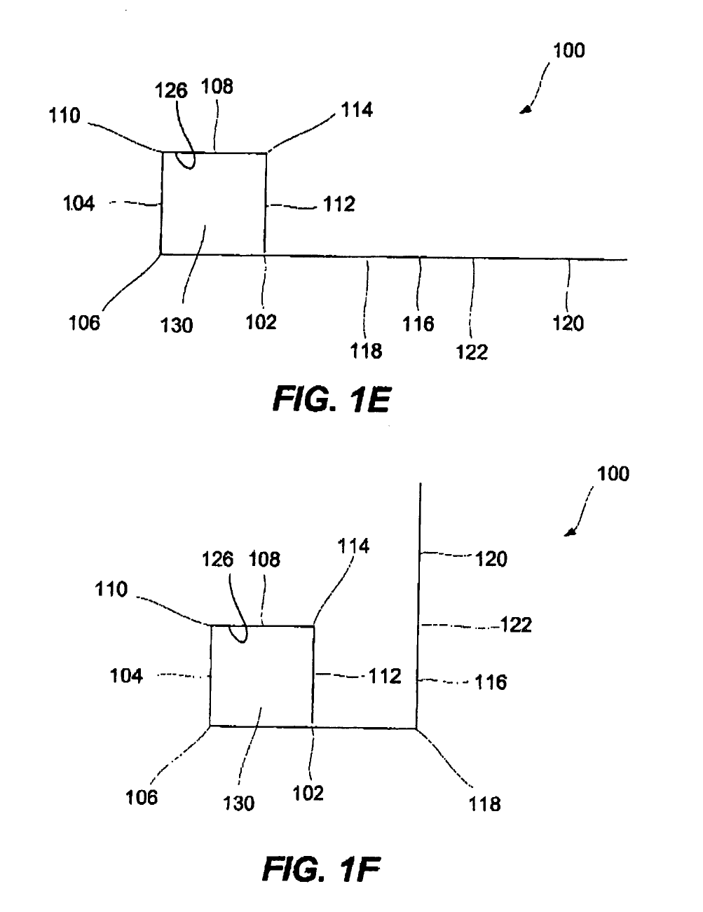

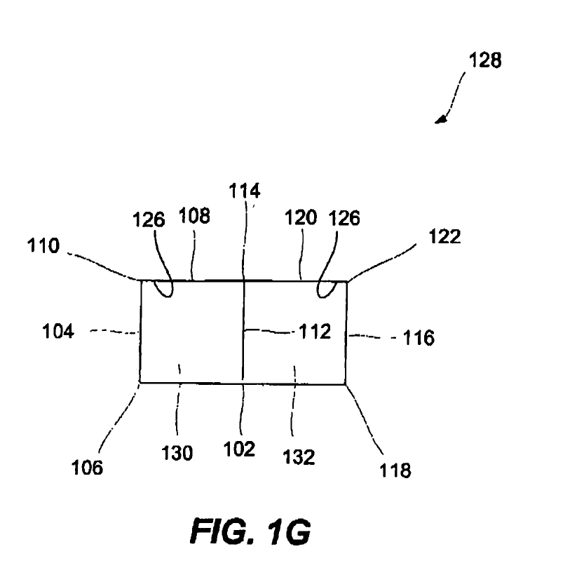

FIG. 1A depicts an exemplary blank 100 according to various aspects of the present invention. The blank 100 includes a first panel (or “base panel”) 102 joined to a second panel (or “first side panel”) 104 along a fold line 106. A third panel (or “first top panel”) 108 is joined to the second panel 104 along a fold line 110. A fourth panel (or “center panel”) 112 is joined to the third panel 108 along a fold line 114. A fifth panel (or “second side panel”) 116 is joined to the first panel 102 along a fold line 118. A sixth panel (or “second top panel”) 120 is joined to the fifth panel 116 along a fold line 122. If desired, the sixth panel 120 may have chamfered corners 124.

In this example, each of the various panels that form the blank 100 is substantially rectangular in shape. However, in this and other aspects of the invention, it will be understood that numerous suitable shapes and configurations may be used to form the base. Examples of other shapes encompassed hereby include, but are not limited to, polygons, circles, ovals, or any other regular or irregular shape. The shape of each panel may be determined by the shape of the food item, and it should be understood that different packages are contemplated for different food items, for example, egg rolls, spring rolls, taquitos, burritos, sandwiches, pizzas, French fries, soft pretzels, pizza bites, cheese sticks, pastries, doughs, and so forth.

Numerous materials may be suitable for use in forming the various blanks and constructs of the invention, provided that the materials are resistant to softening, scorching, combusting, or degrading at typical microwave oven heating temperatures, for example, at from about 250° F. to about 425° F. The particular materials used may include microwave energy interactive materials and microwave energy transparent or inactive materials.

For example, any of the various blanks or constructs of the present invention may include one or more features that alter the effect of microwave energy during the heating or cooking of the food item. For example, the blank or construct may be formed at least partially from one or more microwave energy interactive elements (hereinafter sometimes referred to as “microwave interactive elements”) that promote browning and/or crisping of a particular area of the food item, shield a particular area of the food item from microwave energy to prevent overcooling thereof or transmit microwave energy toward or away from a particular area of the food item. Each microwave interactive element comprises one or more microwave energy interactive materials or segments arranged in a particular configuration to absorb microwave energy, transmit microwave energy, reflect microwave energy, or direct microwave energy, as needed or desired for a particular microwave heating construct and food item.

The microwave interactive element may be supported on a microwave inactive or transparent substrate for ease of handling and/or to prevent contact between the microwave interactive material and the food item. As a matter of convenience and not limitation, and although it is understood that a microwave interactive element supported on a microwave transparent substrate includes both microwave interactive and microwave inactive elements or components, such constructs are referred to herein as “microwave interactive webs”.

The microwave energy interactive material may be an electroconductive or semiconductive material, for example, a metal or a metal alloy provided as a metal foil; a vacuum deposited metal or metal alloy; or a metallic ink, an organic ink, an inorganic ink, a metallic paste, an organic paste, an inorganic paste, or any combination thereof. Examples of metals and metal alloys that may be suitable for use with the present invention include, but are not limited to, aluminum, chromium, copper, inconel alloys (nickel-chromium-molybdenum alloy with niobium), iron, magnesium, nickel, stainless steel, tin, titanium, tungsten, and any combination or alloy thereof.

Alternatively, the microwave energy interactive material may comprise a metal oxide. Examples of metal oxides that may be suitable for use with the present invention include, but are not limited to, oxides of aluminum, iron, and tin, used in conjunction with an electrically conductive material where needed. Another example of a metal oxide that may be suitable for use with the present invention is indium tin oxide (ITO). ITO can be used as a microwave energy interactive material to provide a heating effect, a shielding effect, a browning and/or crisping effect, or a combination thereof. For example, to form a susceptor, ITO may be sputtered onto a clear polymeric film. The sputtering process typically occurs at a lower temperature than the evaporative deposition process used for metal deposition. ITO has a more uniform crystal structure and, therefore, is clear at most coating thicknesses. Additionally, ITO can be used for either heating or field management effects. ITO also may have fewer defects than metals, thereby making thick coatings of ITO more suitable for field management than thick coatings of metals, such as aluminum.

Alternatively, the microwave energy interactive material may comprise a suitable electroconductive, semiconductive, or non-conductive artificial dielectric or ferroelectric. Artificial dielectrics comprise conductive, subdivided material in a polymeric or other suitable matrix or binder, and may include flakes of an electroconductive metal, for example, aluminum.

In one example, the microwave interactive element may comprise a thin layer of microwave interactive material that tends to absorb microwave energy, thereby generating heat at the interface with a food item. Such elements often are used to promote browning and/or crisping of the surface of a food item (sometimes referred to as a “browning and/or crisping element”). When supported on a film or other substrate, such an element may be referred to as a “susceptor film” or, simply, “susceptor”. For example, as shown in FIG. 1A, a susceptor film 126 may overlie and be joined to at least a portion of the various panels 102, 104, 108, 112, 116, 120. However, other microwave energy interactive elements, such as those described herein, are contemplated hereby.

For example, the microwave interactive element may comprise a foil having a thickness sufficient to shield one or more selected portions of the food item form microwave energy (sometimes referred to as a “shielding element”). Such shielding elements may be used where the food item is prone to scorching or drying out during heating.

The shielding element may be formed from various materials and may have various configurations, depending on the particular application for which the shielding element is used. Typically, the shielding element is formed from a conductive, reflective metal or metal alloy, for example, aluminum, copper, or stainless steel. The shielding element generally may have a thickness of from about 0.000285 inches to about 0.05 inches. In one aspect, the shielding element has a thickness of from about 0.0003 inches to about 0.03 inches. In another aspect, the shielding element has a thickness of from about 0.00035 inches to about 0.020 inches, for example, 0.016 inches.

As still another example, the microwave interactive element may comprise a segmented foil, such as, but not limited to, those described in U.S. Pat. Nos. 6,204,492, 6,433,322, 6,552,315, and 6,677,563, each of which is incorporated by reference in its entirety. Although segmented foils are not continuous, appropriately spaced groupings of such segments often act as a transmitting element to direct microwave energy to specific areas of the food item. Such foils also may be used in combination with browning and/or crisping elements, for example, susceptors. As another example, the microwave interactive element may comprise a foil having a thickness sufficient to shield one or more selected portions of the food item from microwave energy (sometimes referred to as a “shielding element”). Such shielding elements may be used where the food item is prone to scorching or drying out during being.

Any of the numerous microwave interactive elements described herein or contemplated hereby may be substantially continuous, that is, without substantial breaks or interruptions, or may be discontinuous, for example, by including one or more breaks or apertures that transmit microwave energy therethrough. The breaks or apertures may be sized and positioned to heat particular areas of the food item selectively. The number, shape, size, and positioning of such breaks or apertures may vary for a particular application depending on type of construct being formed, the food item to be heated therein or thereon, the desired degree of shielding, browning, and/or crisping, whether direct exposure to microwave energy is needed or desired to attain uniform heating of the food item, the need for regulating the change in temperature of the food item through direct heating, and whether and to what extent there is a need for venting.

It will be understood that the aperture may be a physical aperture or void in the material used to form the construct or may be a non-physical “aperture”. A non-physical aperture may be a portion of the construct that is microwave energy inactive by deactivation or otherwise, or one that is otherwise transparent to microwave energy. Thus, for example, the aperture may be a portion of the construct formed without a microwave energy active material or, alternatively, may be a portion of the construct formed with a microwave energy active material that has been deactivated. While both physical and non-physical apertures allow the food item to be heated directly by the microwave energy, a physical aperture also provides a venting function to allow steam or other vapors to be released from the food item.

As stated above, any of the above elements and numerous others contemplated hereby may be supported on a substrate. The substrate typically comprises an electrical insulator, for example, a polymeric film or material. As used herein the term “polymer” or “polymeric material” includes, but is not limited to, homopolymers, copolymers, such as for example, block, graft, random, and alternating copolymers, terpolymers, etc. and blends and modifications thereof. Furthermore, unless otherwise specifically limited, the term “polymer” shall include all possible geometrical configurations of the molecule. These configurations include, but are not limited to isotactic, syndiotactic, and random symmetries.

The thickness of the film typically may be from about 35 gauge to about 10 mil. In one aspect, the thickness of the film is from about 40 to about 80 gauge. In another aspect, the thickness of the film is from about 45 to about 50 gauge. In still another aspect, the thickness of the film is about 48 gauge. Examples of polymeric films that may be suitable include, but are not limited to, polyolefins, polyesters, polyamides, polyimides, polysulfones, polyether ketones, cellophanes, or any combination thereof. Other non-conducting substrate materials such as paper and paper laminates, metal oxides, silicates, cellulosics, or any combination thereof, also may be used.

In one example, the polymeric film comprises polyethylene terephthalate (PET). Polyethylene terephthalate films are used in commercially available susceptors, for example, the QWIKWAVE® Focus susceptor and the MICRORITE® susceptor, both available from Graphic Packaging International (Marietta, Ga.). Examples of polyethylene terephthalate films that may be suitable for use as the substrate include, but are not limited to, MELINEX®, commercially available from DuPont Teijan Films (Hopewell, Va.), SKYROL, commercially available from SKC, Inc. (Covington, Ga.), and BARRIALOX PET, available from Toray Films (Front Royal, Va.), and QU50 High Barrier Coated PET, available from Toray Films (Front Royal, Va.).

The polymeric film may be selected to impart various properties to the microwave interactive web, for example, printability, heat resistance, or any other property. As one particular example, the polymeric film may be selected to provide a water barrier, oxygen barrier, or a combination thereof. Such barrier film layers may be formed from a polymer film having barrier properties or from any other barrier layer or coating as desired. Suitable polymer films may include, but are not limited to, ethylene vinyl alcohol, barrier nylon, polyvinylidene chloride, barrier fluoropolymer, nylon 6, nylon 6,6, coextruded nylon 6/EVOH/nylon 6, silicon oxide coated film, barrier polyethylene terephthalate, or any combination thereof.

One example of a barrier film that may be suitable for use with the present invention is CAPRAN® EMBLEM 1200M nylon 6, commercially available from Honeywell International (Pottsville, Pa.). Another example of a barrier film that may be suitable is CAPRAN® OXYSHIELD OBS monoaxially oriented coextruded nylon 6/ethylene vinyl alcohol (EVOH)/nylon 6, also commercially available from Honeywell International. Yet another example of a barrier film that may be suitable for use with the present invention is DARTEK® N-201 nylon 6,6, commercially available from Enhance Packaging Technologies (Webster, N.Y.). Additional examples include BARRIALOX PET, available from Toray Films (Front Royal, Va.) and QU50 High Barrier Coated PET, available from Toray Films (Front Royal, Va.), referred to above.

Still other barrier films include silicon oxide coated films, such as those available from Sheldahl Films (Northfield, Minn.). Thus, in one example, a susceptor may have a structure including a film, for example, polyethylene terephthalate, with a layer of silicon oxide coated onto the film, and ITO or other material deposited over the silicon oxide. If needed or desired, additional layers or coatings may be provided to shield the individual layers from damage during processing.

The barrier film may have an oxygen transmission rate (OTR) as measured using ASTM D3985 of less than about 20 cc/m²/day. In one aspect, the barrier film has an OTR of less than about 10 cc/m²/day. In another aspect, the barrier film has an OTR of less than about 1 cc/m²/day. In still another aspect, the barrier film has an OTR of less than about 0.5 cc/m²/day. In yet another aspect, the barrier film has an OTR of less than about 0.1 cc/m²/day.

The barrier film may have a water vapor transmission rate (WVTR) of less than about 100 g/day as measured using ASTM F249. In one aspect, the barrier film has a water vapor transmission rate as measured using ASTM F1249 of less than about 50 g/m²/day. In another aspect, the banner film has a WVTR of less than about 15 g/m²/day. In yet another aspect, the barrier film has a WVTR of less than about 1 g/m²/day. In still another aspect, the barrier film has a WVTR of less than about 0.1 g/m²/day. In a still further aspect, the barrier film has a WVTR of less than about 0.05 g/m²/day.

Other non-conducting substrate materials such as metal oxides, silicates, cellulosics, or any combination thereof, also may be used in accordance with the present invention.

The microwave energy interactive material may be applied to the substrate in any suitable manner, and in some instances, the microwave energy interactive material is printed on, extruded onto, sputtered onto, evaporated on, or laminated to the substrate. The microwave energy interactive material may be applied to de substrate in any pattern, and using any technique, to achieve the desired heating effect of the food item.

For example, the microwave energy interactive material may be provided as a continuous or discontinuous layer or costing including circles, loops, hexagons, islands, squares, rectangles, octagons, and so forth. Examples of various patterns and methods that may be suitable for use with the present invention are provided in U.S. Pat. Nos. 6,765,182; 6,717,121; 6,677,563; 6,552,315; 6,455,827; 6,433,322; 6,410,290; 6,251,451; 6,204,492; 6,150,646; 6,114,679; 5,800,724; 5,759,418; 5,672,407; 5,628,921; 5,519,195; 5,420,517; 5,410,135; 5,354,973; 5,340,436; 5,266,386; 5,260,537; 5,221,419; 5,213,902; 5,117,078; 5,039,364; 4,963,420; 4,936,935; 4,890,439; 4,775,771; 4,865,921, and Re. 34,683, each of which is incorporated by reference herein in its entirety. Although particular examples of patterns of microwave energy interactive material are shown and described herein, it should be understood that other patterns of microwave energy interactive material are contemplated by the present invention.

The microwave interactive element or microwave interactive web may be joined to or overlie a dimensionally stable, microwave energy transparent support (hereinafter referred to as “microwave transparent support”, “microwave inactive support” or “support”) to form the construct.

In one aspect, for example, where a rigid or semi-rigid construct is to be formed, all or a portion of the support may be formed at least partially from a paperboard material, which may be cut into a blank prior to use in the construct. For example, the support may be formed from paperboard having a basis weight of from about 60 to about 330 lbs/ream, for example, from about 80 to about 140 lbs/ream. The paperboard generally may have a thickness of from about 6 to about 30 mils, for example, from about 12 to about 28 mils. In one particular example, the paperboard has a thickness of about 12 mils. Any suitable paperboard may be used, for example, a solid bleached or solid unbleached sulfate board, such as SUSO board, commercially available from Graphic Packaging International.

In another aspect, where a more flexible construct is to be formed, the support may comprise a paper or paper-based material generally having a basis weight of from about 15 to about 60 lbs/ream, for example, from about 20 to about 40 lbs/ream. In one particular example, the paper has a basis weight of about 25 lbs/ream.

Optionally, one or sore portions of the various blanks or other constructs described herein or contemplated hereby may be coated with varnish, clay, or other materials, either alone or in combination. The coating may then be printed over with product advertising or other information or images. The blanks or other constructs also may be coated to protect any information printed thereon.

Furthermore, the blank or other constructs may be coated with, for example, a moisture and/or oxygen barrier layer, on either or both sides, such as those described above. Any suitable moisture and/or oxygen barrier material may be used in accordance with the present invention. Examples of materials that may be suitable include, but are not limited to, polyvinylidene chloride, ethylene vinyl alcohol, DuPont DARTEK™ nylon 6,6, and others referred to above.

Alternatively or additionally, any of the blanks or other constructs of the present invention may be coated or laminated with other materials to impart other properties, such as absorbency, repellency, opacity, color, printabillty, stiffness, or cushioning. For example, absorbent susceptors are described in U.S. Provisional Application No. 60/604,637, filed Aug. 25, 2004, and U.S. patent application Ser. No. 11/211,854, to Middleton, et al., titled “Absorbent Microwave Interactive Packaging”, filed Aug. 25, 2005, both of which are incorporated herein by reference in their entirety. Additionally, the blanks or other constructs may include graphics or indicia printed thereon.

It will be understood that with some combinations of elements and materials, the microwave interactive element may have a grey or silver color this is visually distinguishable from the substrate or the support. However, in some instances, it may be desirable to provide a web or construct having a uniform color and/or appearance. Such a web or construct may be more aesthetically pleasing to a consumer, particularly when the consumer is accustomed to packages or containers having certain visual attributes, for example, a solid color, a particular pattern, and so on. Thus, for example, the present invention contemplates using a silver or grey toned adhesive to join the microwave interactive elements to the substrate, using a silver or grey toned substrate to mask the presence of the silver or grey toned microwave interactive element, using a dark toned substrate, for example, a black toned substrate, to conceal the presence of the silver or grey toned microwave interactive element, overprinting the metalized side of the web with a silver or grey toned ink to obscure the color variation, printing the non-metallized side of the web with a silver or grey ink or other concealing color in a suitable pattern or as a solid color layer to mask or conceal the presence of the microwave interactive element, or any other suitable technique or combination thereof.

FIGS. 1B-1F schematically illustrate an exemplary sequence or method of forming a construct 128 from the blank 100 of FIG. 1A. However, it will be understood that numerous other sequences and methods for forming a construct from the blank are contemplated hereby. FIG. 1B depicts a schematic side plan view of the blank 100 in au unfolded configuration. As shown in FIG. 1C, blank 100 can be folded along fold line 106, such that the various panels 104, 108, 112 are substantially perpendicular to the remainder of the blank 100, including panels 102, 116, and 120. Next, as shown in FIG. 10, blank 100 can be folded along fold line 110, such that panel 104 remains substantially perpendicular to the base 102 and panels 108 and 112 are substantially perpendicular to panel 104. In this configuration, panels 108 and 112 also may be substantially parallel to base 102, although it is understood that such characterizations are not exact and that variations are contemplated hereby. Turning now to FIG. 1E, the blank 100 then may be folded along fold line 114, such that panel 112 is substantially perpendicular to the panels 102 and 108. In this configuration, a first chamber or compartment 130 is formed, substantially bisecting a dimension of the base 102 extending between the first side panel 104 and the second side panel 116. The microwave energy interactive element, for example, susceptor 126, overlies at least a portion of each panel 102, 104, 108, 112 facing the interior of the chamber 130.

Now viewing FIG. 1F, the blank 100 may be folded along fold line 118, such that panels 116 and 120 are substantially perpendicular to the base 102. Finally, as shown in FIG. 1G, the blank 100 then may be folded along fold line 122 such that panel 120 at least partially overlaps panel 108 to form a second chamber or compartment 132. If desired, panel 120 may be joined to panel 108 removably or fixedly using any suitable adhesive or mechanical joining or fastening technique, for example, gluing, fusing, or stapling. The second chamber 132 includes a microwave energy interactive element, for example, susceptor 126, overlying at least a portion of panels 102, 116, and 120 on the interior surface thereof. In one aspect, the susceptor 126 overlies the portion of panel 120 that overlaps with panel 108. In another aspect, the susceptor 126 does not overlie the portion of panel 120 that overlaps with panel 108.

To use the construct or carton 128 one or more of the same or different food items (not shown) may be placed in each of the first chamber 130 and the second chamber 132. The construct 128 with the food item therein is placed into a microwave oven (not shown) and heated. The presence of the susceptor 126 overlying the interior surface of each chamber 130, 132 enhances the heating, browning, and/or crisping of the surface of the food item or items contained therein. It is noted that, in this example, the second chamber 132 has less susceptor 126 area available for enhancing the heating, browning, and/or crisping of the food item. As such, the user may be advised to rotate or invert the food items within each chamber or between the chambers 130, 132 during the heating cycle.

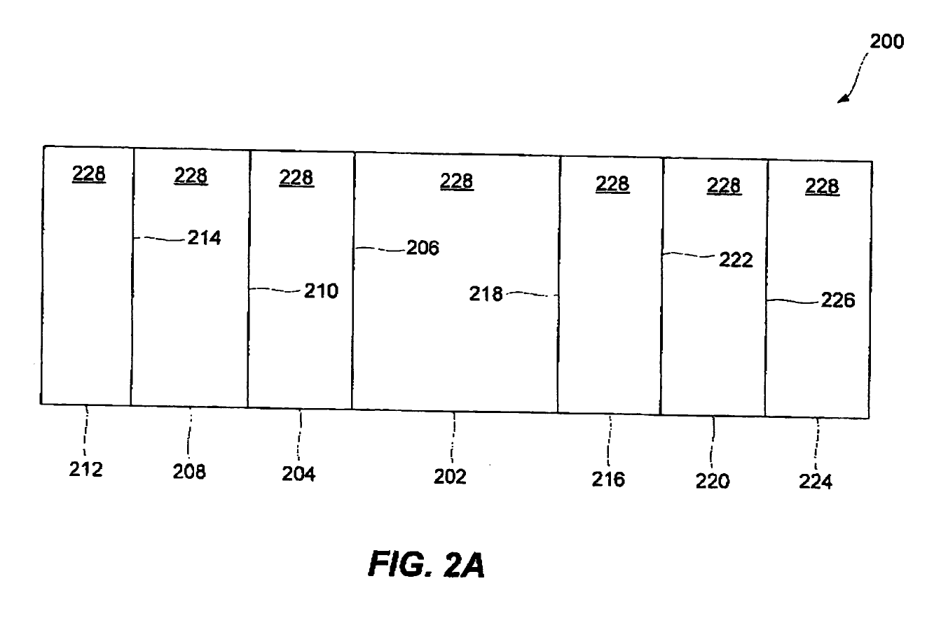

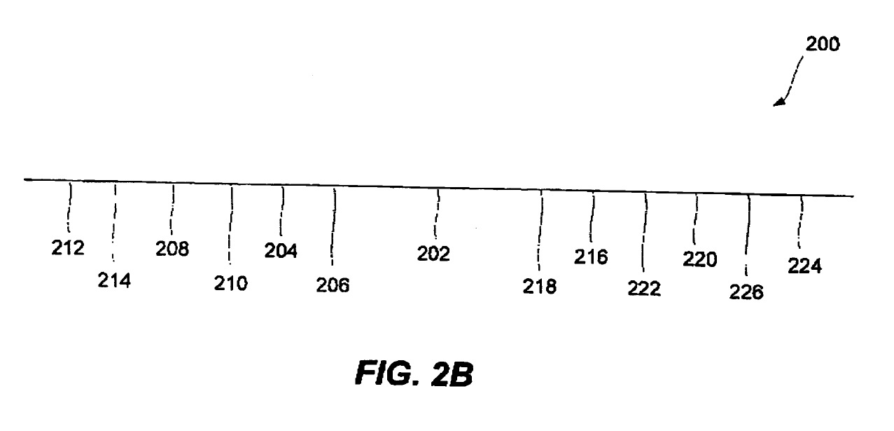

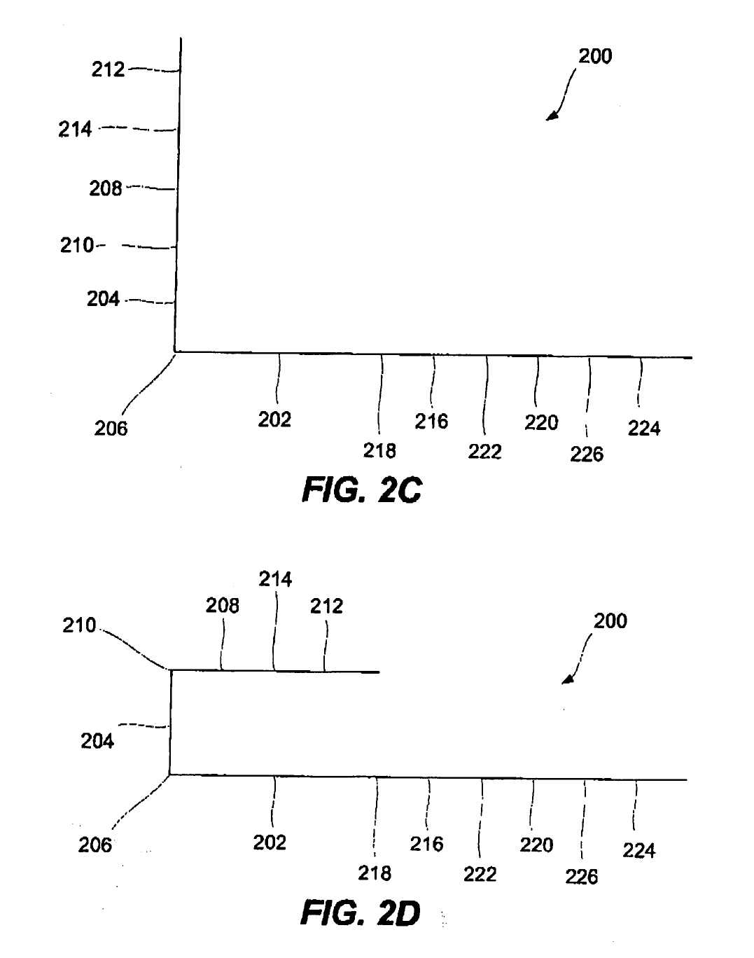

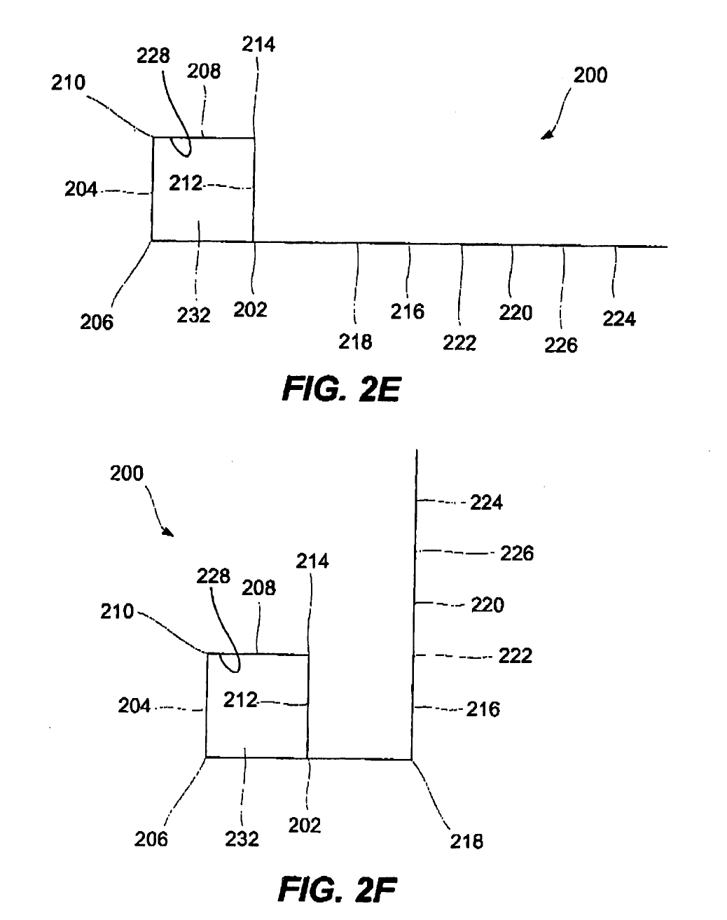

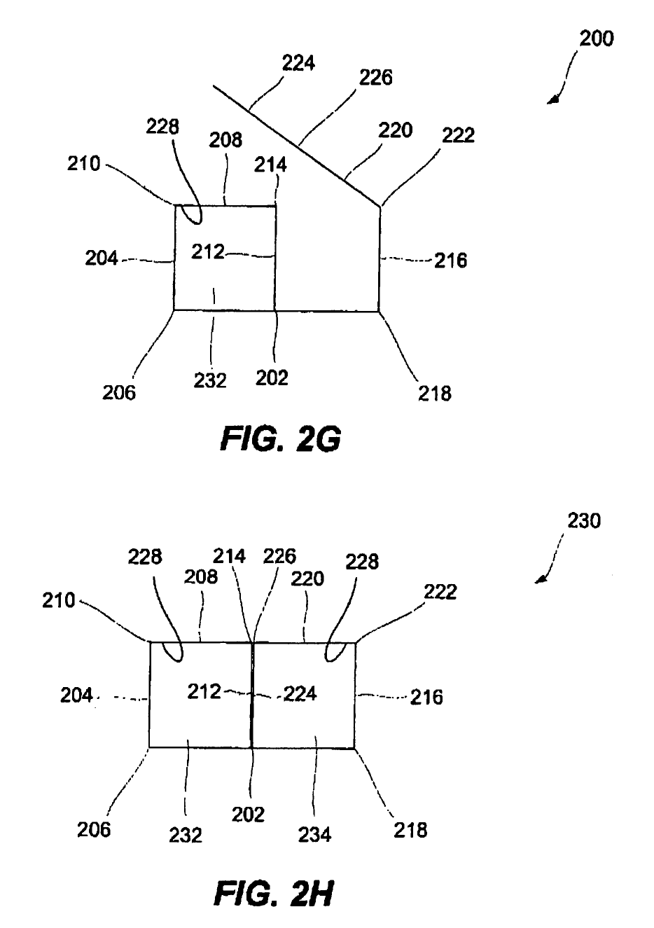

FIG. 2A depicts another exemplary blank 200 that may be used according to various aspects of the invention. The blank 200 includes a first panel (or “base panel”) 202 joined to a second panel (or “first side panel”) 204 along a fold line 206. A third panel (or “first top panel”) 208 is joined to the second panel 204 along a fold line 210. A fourth panel (or “first center panel”) 212 is joined to the third panel 208 along a fold line 214. A fifth panel (or “second side panel”) 216 is joined to the first panel 202 along a fold line 218. A sixth panel (or “second top panel”) 220 is joined to the fifth panel 216 along a fold line 222. A seventh panel (or “second center panel”) 224 is joined to the sixth panel 220 along a fold line 226. A microwave energy interactive element, for example, a susceptor 228 overlies and is joined to at least a portion of each panel 202, 204, 208, 212, 216, 220, 224. Other microwave energy interactive elements are contemplated hereby.

FIGS. 2B-2H illustrate one exemplary sequence of steps that may be used to form a construct 230 from the blank 200 of FIG. 2A. However, it will be understood that numerous other sequences and methods for forming a construct frown the blank are contemplated hereby. FIG. 2B depicts a schematic side plan view of the blank 200 in an unfolded configuration. As shown in FIG. 2C, blank 200 can be folded along fold line 206, such that the various panels 204, 208, 212 are substantially perpendicular to the remainder of the blank 200, including panels 202, 216, and 220.

Next, as shown in FIG. 2D, blank 200 can be folded along fold line 210, such that panel 204 remains substantially perpendicular to the base 202 and panels 208 and 212 are substantially perpendicular to panel 204. In this configuration, panels 208 and 212 also may be substantially parallel to base 202, although it is understood that such characterizations are not exact and that variations are contemplated hereby.

Turning now to FIG. 2E, the blank 200 then may be folded along fold line 214, such that panel 212 is substantially perpendicular to the panels 202 and 208. In this configuration, a first chamber or compartment 232 is formed. The microwave energy interactive element, for example, susceptor 228, overlies at least a portion of each panel 202, 204, 208, 212 facing the interior of the chamber 232.

Now viewing FIG. 1F, the blank 200 may be folded along fold line 218, such that panels 216, 220, and 224 are substantially perpendicular to the base 202. Next, as shown in FIGS. 1G and 1H, the blank 200 then may be folded along fold lines 222 and 226 such that panel 224 is at least partially superposed with panel 212 to form a second chamber or compartment 234. If desired, panel 224 may be joined to panel 212 removably or fixedly using any suitable adhesive or mechanical joining or fastening technique, for example, gluing, fusing, or stapling. The second chamber 234 includes a microwave energy interactive element 228 overlying at least a portion of panels 202, 216, 220, and 224 on the interior surface thereof.

To use the construct 230, one or more of the same or different food items (not shown) may be placed in each of the first chamber 232 and the second chamber 234. The construct 230 with the food item therein then may be placed into a microwave oven and heated. If desired, the user may be advised to rotate or invert the food items within each chamber or between the chambers 232, 234 during the heating cycle. The presence of the susceptor 228 overlying the interior surface of each chamber 232, 234 enhances the heating, browning, and/or crisping of the surface of the food item or items (not shown) contained therein.

It is contemplated that some food items to be heated, browned, and/or crisped may have an irregular surface. In such instances, the various blanks and constructs of the invention may include a microwave energy interactive element that conforms to the shape of the food item during heating. For example, if desired, a combination of paper layers, polymer film layers, and microwave interactive elements may be used to form a microwave energy interactive insulating material. As used herein, the term “microwave energy interactive insulating material” or “microwave interactive insulating material” or “insulating material” refers any combination of layers of materials that is both responsive to microwave energy and capable of providing some degree of thermal insulation when used to heat a food item. An insulating material may be used to form all or a portion of a construct in accordance with the present invention. For example, the insulating material may comprise a patch that overlies a portion of one or more panels of a blank or construct, or may comprise a continuous or discontinuous layer that overlies all or a portion of one or more panels of a blank or construct.

The insulating material may include various components, provided that each is resistant to softening, scorching, combusting, or degrading at typical microwave oven heating temperatures, for example, at from about 250° F. to about 425° F. The insulating material may include both microwave energy responsive or interactive components, and microwave energy transparent or inactive components.

In one aspect, the insulating material comprises one or more susceptor layers in combination with one or more expandable insulating cells. Additionally, the insulating material may include one or more microwave energy transparent or inactive materials to provide dimensional stability, to improve ease of handling the microwave energy interactive material, and/or to prevent contact between the microwave energy interactive material and the food item. For example, an insulating material may comprise a microwave energy interactive material supported on a first polymeric film layer, a moisture-containing layer superposed with the microwave energy interactive material, and a second polymeric film layer joined to the moisture-containing layer in a predetermined pattern, thereby forming one or more closed cells between the moisture-containing layer and the second polymeric film layer. The closed cells expand or inflate in response to being exposed to microwave energy, and thereby causing microwave energy interactive material to bulge and deform.

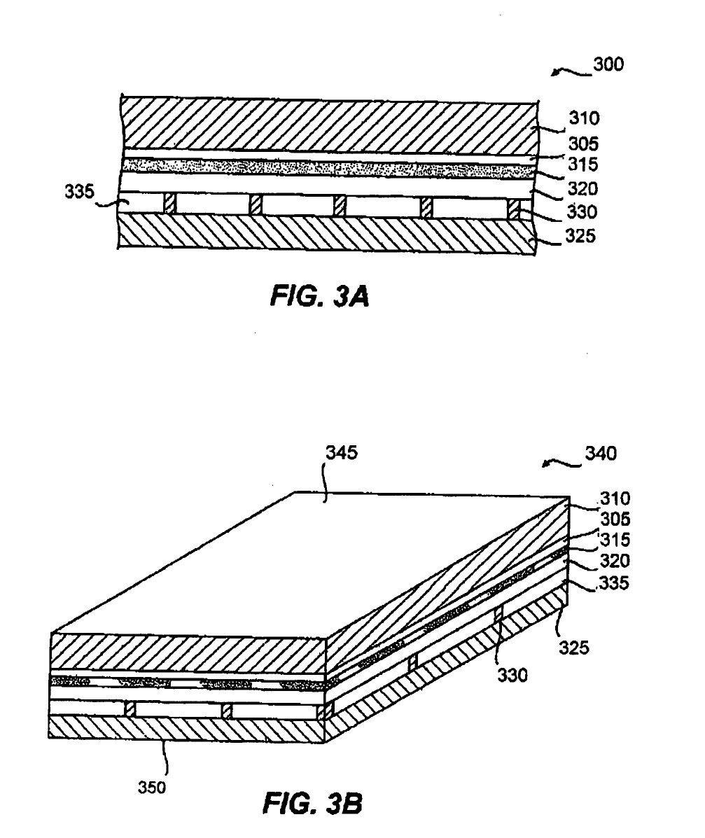

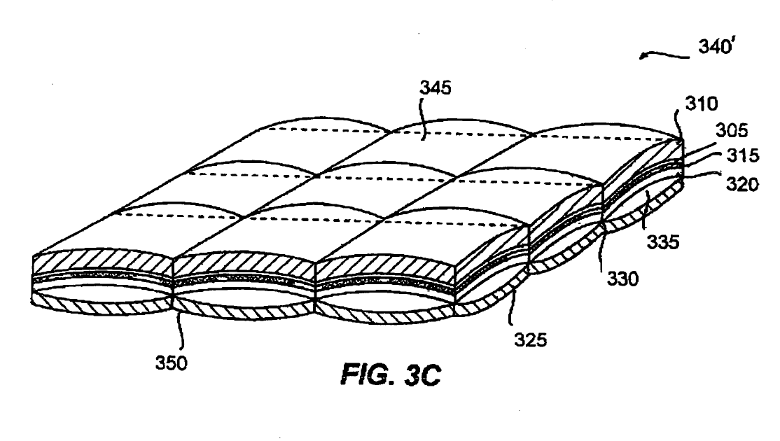

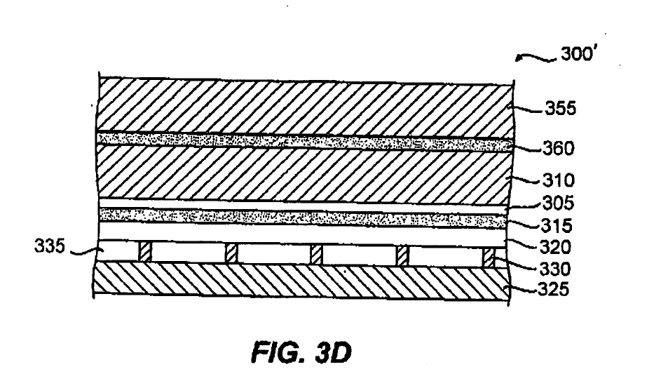

Several exemplary insulating materials are depicted in FIGS. 3A-6C. For purposes of simplicity, like numerals may be used to describe like features. It will be understood that where a plurality of similar features are depicted, not, all of such features are necessarily labeled on each figure. While various exemplary embodiments are shown and described in detail herein, it also will be understood that any of the features may be used in any combination, and that such combinations are contemplated hereby. Further, in each of the examples shown herein, it should be understood that the layer widths are not necessarily shown in perspective. In some instances, for example, the adhesive layers may be very thin with respect to other layers, but are nonetheless shown with some thickness for purposes of clearly illustrating the arrangement of layers.

FIG. 3A depicts an exemplary insulating material 300 that may be used with various aspects of the invention. In this example, a thin layer of microwave energy interactive material 305 is supported on a first polymeric film 310 and bonded by lamination with an adhesive 315 (or otherwise) to a dimensionally stable substrate 320, for example, paper. The substrate 320 is bonded to a second plastic film 325 using a patterned adhesive 330 or other material, such that closed cells 335 are formed in the material 300. The insulating material 300 may be cut and provided as a substantially flat, multi-layered sheet 340, as shown in FIG. 3B.

As the microwave energy interactive material 305 heats upon impingement by microwave energy, water vapor and other gases typically held in the substrate 320, for example, paper, and any air trapped in the thin space between the second plastic film 325 and the substrate 320 in the closed cells 335, expand, as shown in FIG. 3C. The resulting insulating material 340′ has a quilted or pillowed top surface 345 and bottom surface 350. When microwave heating has ceased, the cells 335 typically deflate and return to a somewhat flattened state. In some instances, however, the insulating material may remain at least partially expanded, as will be discussed below.

Optionally, the insulating material 300′ may include an additional microwave transparent layer 355 adhered by adhesive 360 or otherwise to the polymeric film 310 opposite the microwave energy interactive material 305, as depicted in FIG. 3D. The additional microwave transparent layer 355 may be a layer of paper, film, or any other suitable material, and may be provided to shield the food item (not shown) from any flakes of susceptor film that craze and peel away from the insulating material 300′ during heating.

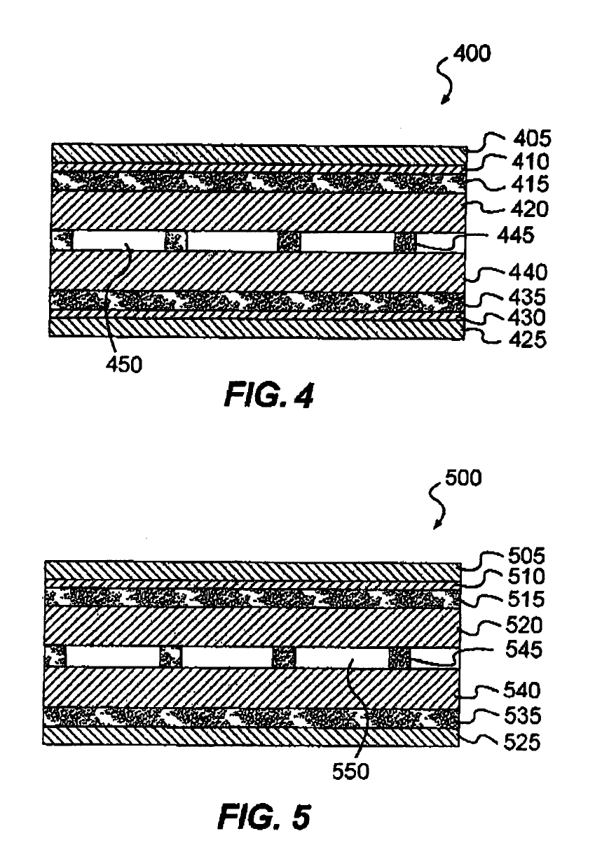

FIGS. 4 and 5 depict other exemplary insulating materials according to various aspects of the present invention. Referring first to FIG. 4, an insulating material 400 is shown with two symmetrical layer arrangements adhered together by a patterned adhesive layer. The first symmetrical layer arrangement, beginning at the top of the drawings, comprises a PET film layer 405, a metal layer 410, an adhesive layer 415, and a paper or paperboard layer 440. The metal layer 410 may comprise a metal, such as aluminum, deposited along at least a portion of the PET film layer 405. The PET film 405 and metal layer 410 together define a susceptor. The adhesive layer 415 bonds the PET film 405 and the metal layer 410 to the paperboard layer 420.

The second symmetrical layer arrangement, beginning at the bottom of the drawings, also comprises a PET film layer 425, a metal layer 430, an adhesive layer 435, and a paper or paperboard layer 440. If desired, the two symmetrical arrangements may be formed by folding one layer arrangement onto itself. The layers of the second symmetrical layer arrangement are bonded together in a similar manner as the layers of the first symmetrical arrangement. A patterned adhesive layer 445 is provided between the two paper layers 420 and 440, and defines a pattern of closed cells 450 configured to expand when exposed to microwave energy. By using an insulating material 400 having two metal layers 410 and 430, more heat is generated, thereby achieving greater cell loft. As a result, such a material is able to elevate a food item seated thereon to a greater extent than an insulating material having a single microwave energy interactive material layer.

Referring to FIG. 5, yet another insulating material 500 is shown. The material 500 includes a PET film layer 505, a metal layer 510, an adhesive layer 515, and a paper layer 520. Additionally, the material 500 may include a clear PET film layer 525, an adhesive 535, and a paper layer 540. The layers are adhered or affixed by a patterned adhesive 545 defining a plurality of closed expandable cells 550.

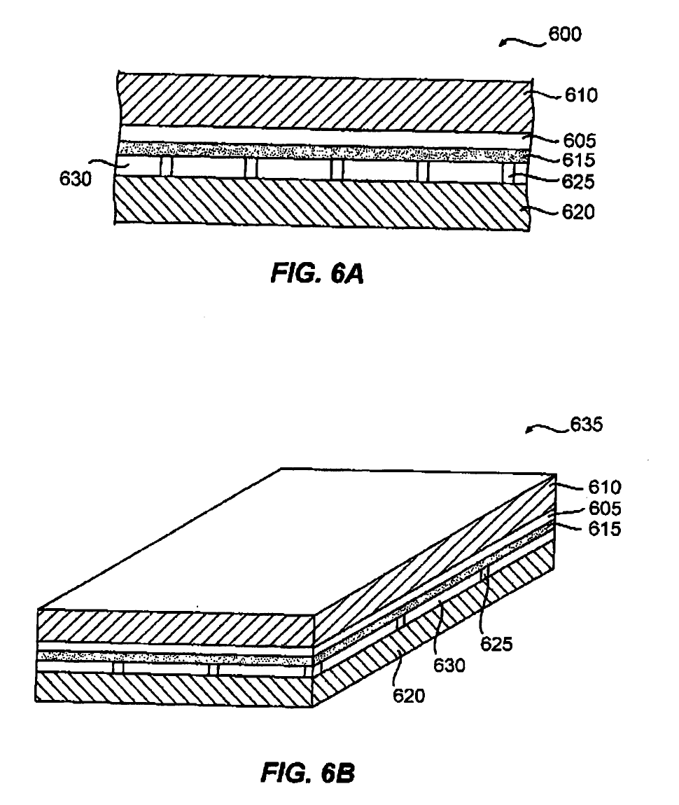

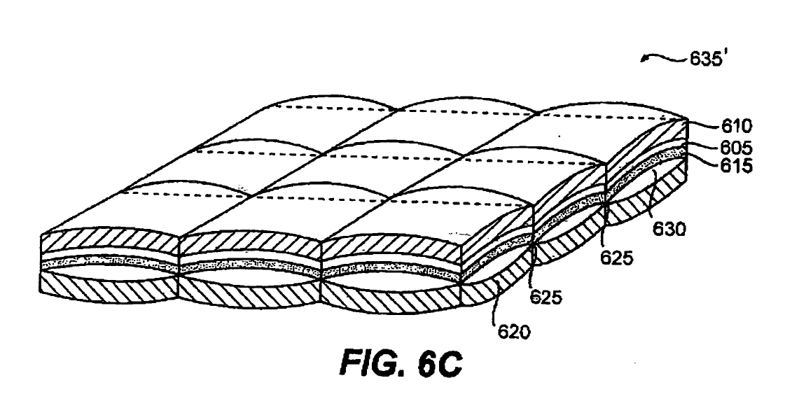

Turning now to FIGS. 6A-6C, another exemplary insulating material 600 is depicted. In this example, one or more reagents are used to generate a gas that expands the cells of the insulating material. In this example, one or more reagents are used to generate a gas that expands the cells of the insulating material. For example, the reagents may comprise sodium bicarbonate (NaHCO₃) and a suitable acid. When exposed to heat, the reagents react to produce carbon dioxide. As another example, the reagent may comprise a blowing agent. Examples of blowing agents that may be suitable include, but are not limited to, p-p′-oxybis(benzenesulphonylhydrazide), azodicarbonamide, and p-toluenesulfonylenicarbazide. However, it will be understood that numerous other reagents and released gases are contemplated hereby.

In the example shown in FIG. 6A, a thin layer of microwave interactive material 605 is supported on a first plastic film 610 to form a susceptor film. One or more reagents 615, optionally within a coating, overlie at least a portion of the layer of microwave interactive material 605. The reagent 615 is joined to a second plastic film 620 using a patterned adhesive 625 or other material, or using thermal bonding, ultrasonic bonding, or any other suitable technique, such that closed cells 630 (shown as a void) are formed in the material 600. The insulating material 600 may be cut into a sheet 635, as shown in FIG. 6B.

FIG. 6C depicts the exemplary insulating material 635 of FIG. 6B after being exposed to microwave energy from a microwave oven (not shown). As the microwave interactive material 605 heats upon impingement by microwave energy, water vapor or other gases are released from or generated by the reagent 615. The resulting gas applies pressure on the susceptor film 610 on one side and the second plastic film 620 on the other side of the closed cells 630. Each side of the material 600 forming the closed cells 630 reacts simultaneously, but uniquely, to the heating and vapor expansion to form a quilted insulating material 635′. This expansion may occur within 1 to 15 seconds in an energized microwave oven, and in some instances, may occur within 2 to 10 seconds. Even without a paper or paperboard layer, the water vapor resulting from the reagent is sufficient both to inflate the expandable cells and to absorb any excess heat from the microwave energy interactive material.

Typically, when microwave heating has ceased, the cells or quilts may deflate and return to a somewhat flattened state. Alternatively, the insulating material may comprise a durably expandable microwave energy interactive insulating material. As used herein, the term “durably expandable microwave energy interactive insulating material” or “durably expandable insulating material” refers to an insulating material that includes expandable cells that tend to remain at least partially, substantially, or completely inflated after exposure to microwave energy has been terminated. Such materials may be used to form multi-functional packages and other constructs that can be used to heat a food item, to provide a surface for safe and comfortable handling of the food item, and to contain the food item after heating Thus, a durably expandable insulating material may be used to form a package or construct that facilitates storage, preparation, transportation, and consumption of a food item, even “on the go”.

In one aspect, a substantial portion of the plurality of cells remain substantially expanded for at least about 1 minute after exposure to microwave energy has ceased. In another aspect, a substantial portion of the plurality of cells remain substantially expanded for at least about 5 minutes after exposure to microwave energy has ceased. In still another aspect, a substantial portion of the plurality of cells remain substantially expanded for at least about 10 minutes after exposure to microwave energy has ceased. In yet another aspect, a substantial portion of the plurality of cells remain substantially expanded for at least about 30 minutes after exposure to microwave energy has ceased. It will be understood that not all of the expandable cells in a particular construct or package must remain inflated for the insulating material to be considered to be “durable”. Instead, only a sufficient number of cells must remain inflated to achieve the desired objective of the package or construct in which the material is used.

For example, where a durably expandable insulating material is used to form all or a portion of a package or construct for storing a food item, heating, browning, and/or crisping the food item in a microwave oven, removing it from the microwave oven, and removing it from the construct, only a sufficient number of cells need to remain at least partially inflated for the time required to heat, brown, and/or crisp the food item and remove it from the microwave oven after heating. In contrast, where a durably expandable insulating material is used to form all or a portion of a package or construct for storing a food item, heating, browning, and/or crisping the food item in a microwave oven, removing the food item from the microwave oven, and consuming the food item within the construct, a sufficient number of cells need to remain at least partially inflated for the time required to heat, brown, and/or crisp the food item, remove it from the microwave oven after heating, and transport the food item until the food item and/or construct has cooled to a surface temperature comfortable for contact with the hands of the user.

Any of the durably expandable insulating materials of the present invention may be formed at least partially from one or more barrier materials, for example, polymeric films, that substantially reduce or prevent the transmission of oxygen, water vapor, or other gases from the expanded cells. Examples of such materials are described above. However, the use of other materials is contemplated hereby.

It will be understood that the various insulating materials of the present invention enhance heating, browning, and crisping of food item in a microwave oven. First, the water vapor, air, and other gases contained in the closed cells provide insulation between the food item and the ambient environment of the microwave oven, thereby increasing the amount of sensible heat that stays within or is transferred to the food item. Additionally, the formation of the cells allows the material to conform more closely to the surface of the food item, placing the susceptor film in greater proximity to the food item, thereby enhancing browning and/or crisping. Furthermore, insulating materials may help to retain moisture in the food item when cooking in the microwave oven, thereby improving the texture and flavor of the food item. Additional benefits and aspects of such materials are described in PCT Application No. PCT/US03/03779, U.S. application Ser. No. 10/501,003, and U.S. application Ser. No. 11/314,851, each of which is incorporated by reference herein in its entirety.

Any of the insulating materials described herein or contemplated hereby may include an adhesive pattern or thermal bond pattern that is selected to enhance cooking of a particular food item. For example, where the food item is a larger item, the adhesive pattern may be selected to form substantially uniformly shaped expandable cells. Where the food item is a small item, the adhesive pattern may be selected to form a plurality of different sized cells to allow the individual items to be variably contacted on their various surfaces. While several examples are provided herein, it will be understood that numerous other patterns are contemplated hereby, and the pattern selected will depend on the heating, browning, crisping, and insulating needs of the particular food item.

If desired, multiple layers of insulating materials may be used to enhance the insulating properties of the insulating material and, therefore, enhance the browning and crisping of the food item. Where multiple layers are used, the layers may remain separate or may be joined using any suitable process or technique, for example, thermal bonding, adhesive bonding, ultrasonic bonding or welding, mechanical fastening, or any combination thereof. In one example, two sheets of an insulating material may be arranged so that their respective susceptor film layers are facing away from each other. In another example, two sheets of an insulating material may be arranged so that their respective susceptor film layers are facing towards each other. In still another example, multiple sheets of an insulating material may be arranged in a like manner and superposed. In a still further example, multiple sheets of various insulating materials are superposed in any other configuration as needed or desired for a particular application. Thus, for example, an insulating material may be superposed with one or more additional layers of susceptors or susceptor films.

While various examples of constructs are provided herein, it will be understood that any configuration of components may be used as needed or desired. The construct may be flexible, semi-rigid, rigid, or may include a variety of components having different degrees of flexibility. Additionally, it should be understood that the present invention contemplates constructs for single-serving portions and for multiple-serving portions. It also should be understood that various components used to form the constructs of the present invention may be interchanged. Thus, while only certain combinations are illustrated herein, numerous other combinations and configurations are contemplated hereby.

Although certain embodiments of this invention have been described with a certain degree of particularity, those skilled in the art could make numerous alterations to the disclosed embodiments without departing from the spirit or scope of this invention. All directional references (e.g., upper, lower, upward, downward, left, right, leftward, rightward, top, bottom, above, below, vertical, horizontal, clockwise, and counterclockwise) are used only for identification purposes to aid the reader's understanding of the various embodiments of the present invention, and do not create limitations, particularly as to the position, orientation, or use of the invention unless specifically set forth in the claims. Joinder references (e.g., joined, attached, coupled, connected, and the like) are to be construed broadly and may include intermediate members between a connection of elements and relative movement between elements. As such, joinder references do not necessarily imply that two elements are connected directly and in fixed relation to each other.

It will be recognized by those skilled in the art, that various elements discussed with reference to the various embodiments may be interchanged to create entirely new embodiments coming within the scope of the present invention. It is intended that all matter contained in the above description or shown in the accompanying drawings shall be interpreted as illustrative only and not limiting. Changes in detail or structure may be made without departing from the spirit of the invention. The detailed description set forth herein is not intended nor is to be construed to limit the present invention or otherwise to exclude any such other embodiments, adaptations, variations, modifications, and equivalent arrangements of the present invention.

Accordingly, it will be readily understood by those persons skilled in the art that, in view of the above detailed description of the invention, the present invention is susceptible of broad utility and application. Many adaptations of the present invention other than those herein described, as well as many variations, modifications, and equivalent arrangements will be apparent from or reasonably suggested by the present invention and the above deviled description thereof, without departing from the substance or scope of the present invention as set forth in the appended claims.

While the present invention is described herein in detail in relation to specific aspects, it is to be understood that this detailed description is only illustrative and exemplary of the present invention and is made merely for purposes of providing a full and enabling disclosure of the present invention and to provide the best mode contemplated by the inventor or inventors of carrying out the invention. The detailed description set forth herein is not intended nor is to be construed to limit the present invention or otherwise to exclude any such other embodiments, adaptations, variations, modifications, and equivalent arrangements of the present invention.

What is claimed is:

1. A blank for a construct, composing:
a first panel;
a second panel joined to the first panel along a first fold line;
a third panel joined to the second panel along a second fold line;
a fourth panel joined to the third panel along a third fold line;
a fifth panel joined to the first panel along a fourth fold line; and
a sixth panel joined to the fifth panel along a fifth fold line,
wherein each of the first fold line, second fold line, third fold line, fourth fold line, and fifth fold line are aligned in a substantially parallel configuration with respect to one another.

2. The blank of claim 1, wherein at least one of the first panel, second panel, third panel, fourth panel, and fifth panel is substantially rectangular in shape.

3. The blank of claim 1, wherein each of the first panel, second panel, third panel, fourth panel, and fifth panel is substantially rectangular in shape.

4. The blank of claim 1, wherein the sixth panel is substantially rectangular in shape.

5. The blank of claim 1, wherein the sixth panel is substantially hexagonal in shape.

6. The blank of claim 1, wherein the sixth panel is substantially rectangular in shape with at least one chamfered corner.

7. The blank of claim 1, wherein
each of the first fold line, second fold line, third fold line, fourth fold line, and fifth fold line are substantially equal in length, and
the length of the first fold line, second fold line, third fold line, fourth fold line, and fifth fold line defines a first dimension of each of the first, panel, second panel, third panel, fourth panel, and fifth panel.

8. The blank of claim 1, wherein
each of the first panel, second panel, third panel, fourth panel, fifth panel, and sixth panel has a second dimension substantially transverse to the first fold line, second fold line, third fold line, fourth fold line, and fifth fold line, and
the second dimension of the second panel is approximately equal to that of the fifth panel.

9. The blank of claim 1, wherein
each of the first panel, second panel, third panel, fourth panel, fifth panel, and sixth panel has a second dimension substantially transverse to the first fold line, second fold line, third fold line, fourth fold line, and fifth fold line, and
the second dimension of the sixth panel is greater than the second dimension of the third panel.

10. The blank of claim 1, further comprising a microwave energy interactive element overlying at least one of the first panel, second panel, third panel, fourth panel, fifth panel, or sixth panel.

11. The blank of claim 1, further comprising a susceptor joined to at least a portion of at least one of the first panel, second panel, third panel, fourth panel, fifth panel, or sixth panel.

12. The blank of claim 1, further comprising a microwave energy interactive insulating material, a microwave energy shielding element, a microwave energy directing element, a susceptor, a segmented metal foil, or any combination thereof.

13. The blank of claim 1, wherein
the first panel comprises a base panel,
the second panel comprises a first side panel,
the third panel comprises a first top panel,
the fourth panel comprises a center panel,
the fifth panel comprises a second side panel, and
the sixth panel comprises a second top panel.

14. A method of forming a construct from the blank of claim 1.

15. A construct formed from the blank of claim 1, the construct comprising a base, a pair of opposed side wails, at least one top panel, and an interior wall that at least partially defines a first compartment and a second compartment.

16. The construct of claim 15, wherein the first compartment and the second compartment are substantially the same size and shape.

17. The construct of claim 15, wherein the first compartment and the second compartment differ in size and/or shape.

18. The construct of claim 15, wherein at least one of the first compartment and the second compartment has an interior surface at least partially defined by a microwave energy interactive element.

19. The construct of claim 15, wherein
the first compartment includes an interior surface substantially defined by a microwave energy interactive element, and
the second compartment includes an interior surface partially defined by a microwave energy interactive element.

20. A blank for a construct, comprising:
a first panel;
a second panel joined to the first panel along a first fold line;
a third panel joined to the second panel along a second fold line;
a fourth panel joined to the third panel along a third fold line;
a fifth panel joined to the first panel along a fourth fold line;
a sixth panel joined to the fifth panel along a fifth fold line, and
a seventh panel joined to the sixth panel along a sixth fold line,
wherein the first fold line, second fold line, third fold line, fourth fold line, fifth fold line, and sixth fold line each are aligned in a substantially parallel configuration with respect to one another.

21. The blank of claim 20, wherein at least one of the first panel, second panel, third panel, fourth panel, fifth panel, and sixth panel is substantially rectangular in shape.

22. The blank of claim 20, wherein the first panel, second panel, third panel, fourth panel, fifth panel, and sixth panel each are substantially rectangular in shape.

23. The blank of claim 20, wherein
the first fold line, second fold line, third fold line, fourth fold line, fifth fold line, and sixth fold line are substantially equal in length, and
the length of the first fold line, second fold line, third fold line, fourth fold line, fifth fold line, and sixth fold line defines a first dimension of each of the first panel, second panel, third panel, fourth panel, fifth panel, and sixth panel.

24. The blank of claim 23, wherein
each of the first panel, second panel, third panel, fourth panel, fifth panel, and sixth panel has a second dimension substantially transverse to the first fold line, second fold line, third fold line, fourth fold line, fifth fold line, and sixth fold line,
the second dimension of the second panel is approximately equal to that of the fifth panel,
the second dimension of the third panel is approximately equal to that of the sixth panel, and
the second dimension of the fourth panel is approximately equal to that of the seventh panel.

25. The blank of claim 20, further comprising a microwave energy interactive element overlying at least a portion of at least one of the first panel, second panel, third panel, fourth panel, fifth panel, sixth panel, and seventh panel.

26. The blank of claim 20, further comprising a susceptor joined to at least a portion of at least one of the first panel, second panel, third panel, fourth panel, fifth panel, sixth panel, and seventh panel.

27. The blank of claim 20, further comprising a microwave energy interactive insulating material, a microwave energy shielding element, a microwave energy directing element, a susceptor, a segmented metal foil, or any combination thereof.

28. The blank of claim 20, wherein
the first panel comprises a base panel,
the second panel comprises a first side panel,
the third panel comprises a first top panel,
the fourth panel comprises a first center panel,
the fifth panel comprises a second side panel,
the sixth panel comprises a second top panel, and
the seventh panel comprises a second center panel.

29. A method of forming a construct from the blank of claim 20.

30. A construct formed from the blank of claim 20, the construct comprising a base, a pair of opposed side walls, at least one top panel, and a pair of substantially interior walls that collectively define a first compartment and a second compartment.

31. The construct of claim 30, wherein the first compartment and the second compartment are substantially the same size.

32. The construct of claim 30, wherein the first compartment and the second compartment differ in size.

33. The construct of claim 30, wherein at least one of the first compartment and the second compartment has an interior surface at least partially defined by a microwave energy interactive element.

34. The construct of claim 30, wherein the first compartment and the second compartment each have an interior surface substantially defined by a microwave energy interactive element.
